(19) United States
(12) Patent Application Publication
(10) Pub. No.: US 2016/0119121 A1
(43) Pub. Date: Apr. 28, 2016

(54) ENCRYPTION/DECRYPTION APPARATUS AND ENCRYPTION/DECRYPTION METHOD THEREOF

(71) Applicant: Nuvoton Technology Corporation, Hsinchu (TW)

(72) Inventor: Shun-Hsiung Chen, Hsinchu (TW)

(73) Assignee: Nuvoton Technology Corporation, Hsinchu (TW)

(21) Appl. No.: 14/283,227

(22) Filed: May 21, 2014

(30) Foreign Application Priority Data
Aug. 8, 2013 (TW) 102128522

(51) Int. Cl. H04L 9/06; H04L 9/08

(52) U.S. Cl. CPC H04L 9/0631; H04L 9/0822

(57) ABSTRACT

An encryption/decryption apparatus and an encryption/decryption method thereof are provided. A data encryption/decryption unit performs an encryption/decryption operation to a digital data and thus generates an encryption/decryption power signal corresponding to the encryption/decryption operation. A complementary power generating unit generates a complementary power signal corresponding to the encryption/decryption power signal. The encryption/decryption apparatus outputs the complementary power signal and the encryption/decryption power signal as a power signal, wherein a sum of the complementary power signal and the encryption/decryption power signal is a fixed value.

### CROSS-REFERENCE TO RELATED APPLICATION

This application claims the priority benefit of Taiwan application serial no. 102128522, filed on Aug. 8, 2013. The entirety of the above-mentioned patent application is hereby incorporated by reference herein and made a part of this specification.

### BACKGROUND OF THE INVENTION

1. Field of the Invention

The invention relates to an encryption/decryption apparatus and an encryption/decryption method thereof, and particularly relates to an encryption/decryption apparatus capable of defending power analysis attack and an encryption/decryption method thereof.

2. Description of Related Art

Encryption techniques are commonly used to ensure the security of data transmission. Regarding the encryption techniques, an information (plain text) is encrypted at a transmitting end, whereas an information (cipher text) is decrypted or decoded at a receiving end. Such information encryption or decryption is commonly known as the encryption/decryption techniques.

The data encryption standard (DES) is a block-unit encryption protocol used in several countries and particularly the American National Standards Institute (ANSI). In addition, other examples of encryption protocols include 3-DES, Advanced Encryption Standard (AES), and the like. A block-unit encryption protocol defines a plurality of modes, wherein electronic codebook (ECB), cipher block chaining (CBC), output feedback (OFB), cipher feedback, and other similar standards are defined. Recently, the counter mode and offset codebook have been developed as well.

### SUMMARY OF THE INVENTION

An embodiment of the invention provides an encryption/decryption apparatus, adapted to perform an encryption/decryption operation to a digital data and generating a power signal corresponding to the encryption/decryption operation when the encryption/decryption operation is performed. The encryption/decryption apparatus includes a data encryption/decryption unit and a complementary power generating unit. Specifically, a data encryption/decryption unit performs the encryption/decryption operation to the digital data and generates an encryption/decryption power signal in correspondence with the encryption/decryption operation. A complementary power generating unit is coupled to the data encryption/decryption unit and generates a complementary power signal in correspondence with the encryption/decryption power signal, such that the encryption/decryption apparatus outputs the complementary power signal and the encryption/decryption power signal as the power signal, wherein a sum of the complementary power signal and the encryption/decryption power signal is a fixed value.

Another embodiment of the invention also provides an encryption/decryption method of an encryption/decryption apparatus adapted to perform an encryption/decryption operation to a digital data, wherein the encryption/decryption apparatus generates a power signal corresponding to the encryption/decryption operation when the encryption/decryption operation is performed. The encryption/decryption method of the encryption/decryption apparatus includes the following. The encryption/decryption operation is performed to the digital data and an encryption/decryption power signal is generated in correspondence with the encryption/decryption operation; and A complementary power signal is generated in correspondence with the encryption/decryption power signal, such that the encryption/decryption apparatus outputs the complementary power signal and the encryption/decryption power signal as the power signal, wherein a sum of the complementary power signal and the encryption/decryption power signal is a fixed value.

Another embodiment of the invention further provides an encryption method, including the following. A first key is provided. A second key is generated according to the first key, wherein the second key is 1's complement of the first key. An encryption logic operation is performed to a digital data with the first key and the second key respectively to respectively generate an encryption data.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an encryption/decryption apparatus according to an embodiment of the invention.

FIG. 2 is a schematic view illustrating an encryption/decryption apparatus according to another embodiment of the invention.

FIG. 3 is a schematic view illustrating encryption of the Feistel Function.

FIG. 4A is a schematic view illustrating a logic operation unit performing an exclusive OR operation according to a key and digital data.

FIG. 4B is a schematic view illustrating a complementary power generating unit performing the exclusive OR operation according to the key and digital data.

FIG. 5A is a schematic view illustrating a digital data permutation table.

FIG. 5B is a schematic view illustrating a complementary data permutation table.

FIG. 6 is a schematic flowchart illustrating an encryption/decryption method of an encryption/decryption apparatus according to an embodiment of the invention.

FIG. 7 is a schematic flowchart illustrating an encryption method according to another embodiment of the invention.

FIGS. 8A-8D are schematic views illustrating encryption/decryption in the advanced encryption standard according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Data encryption/decryption algorithms have been broadly used in wireless communication systems such as a wireless local area network, near field communication, data storage system, and bank system. However, in 1999, Kocher et al. published a differential power analysis (DPA), which is capable of effectively compromising an encryption/decryption chip at a low cost.

The so-called differential power analysis attack is to make use of power information revealed from a channel when hardware performs encryption and decryption to derive a key. The power analysis attack may be performed by measuring power consumption of a password complier, for example, or a smart card that receives power externally, for example, wherein current consumption of the smart card may be determined by gate switching decided by an operation currently being performed. A hacker may monitor power consumption of the smart card and infers information about data of interest by calculating information when in control of the smart card. Therefore, how to implement a mechanism to defend the differential power analysis attack in an encryption/decryption chip has become an important issue in designing an encryption/decryption apparatus.

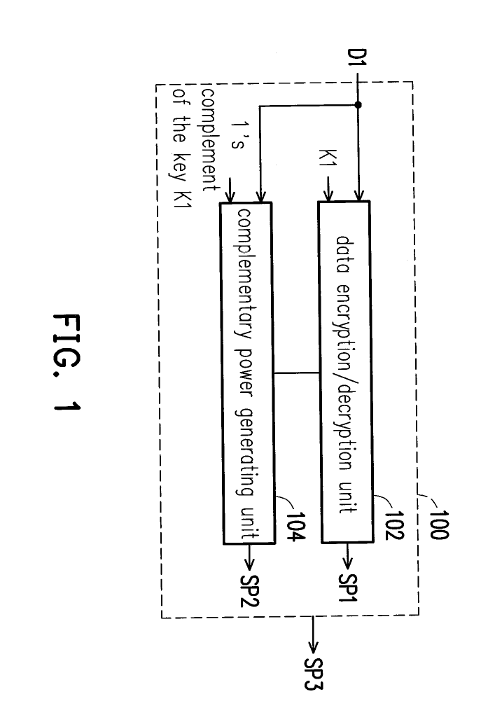

FIG. 1 is a schematic view illustrating an encryption/decryption apparatus according to an embodiment of the invention. Referring to FIG. 1, an encryption/decryption apparatus 100 is configured to perform an encryption/decryption operation to a digital data D1. The encryption/decryption apparatus 100 includes a data encryption/decryption unit 102 and a complementary power generating unit 104. The data encryption/decryption unit 102 is coupled with the complementary power generating unit 104, and is adapted to perform the encryption/decryption operation to the digital data D1 according to a key K1. In addition, when the data encryption/decryption unit 102 performs the encryption/decryption operation, an encryption/decryption power signal SP1 is generated in correspondence with the encryption/decryption operation. The encryption/decryption power signal SP1 is a current signal or a voltage signal, for example. Besides, the complementary power generating unit 104 generates a complementary power signal SP2 according to the digital data D1 and the key K1 (more specifically, 1's complement of the key K1), such that a power signal SP3 generated correspondingly when the encryption/decryption apparatus 100 performs the encryption/decryption operation to the digital data D1 is equal to a sum of the complementary power signal SP2 and the encryption/decryption power signal SP1, wherein given that a number of bit value “1” in the digital data D1 is fixed, the sum of the complementary power signal SP2 and the encryption/decryption power signal SP1 is a fixed value. Namely, a bit value observed from the power signal SP3 by the hacker is a fixed value. Details in this respect are provided hereinafter.

In this way, the complementary power signal SP2 generated by the complementary power generating unit 104 keeps the power signal SP3 generated in correspondence with the encryption/decryption operation by the encryption/decryption apparatus 100 at a fixed value. Namely, keeping the power signal SP3 unable to reveal variation of power during the encryption/decryption operation prevents the hacker from compromising the key K1 by measuring the power signal SP3.

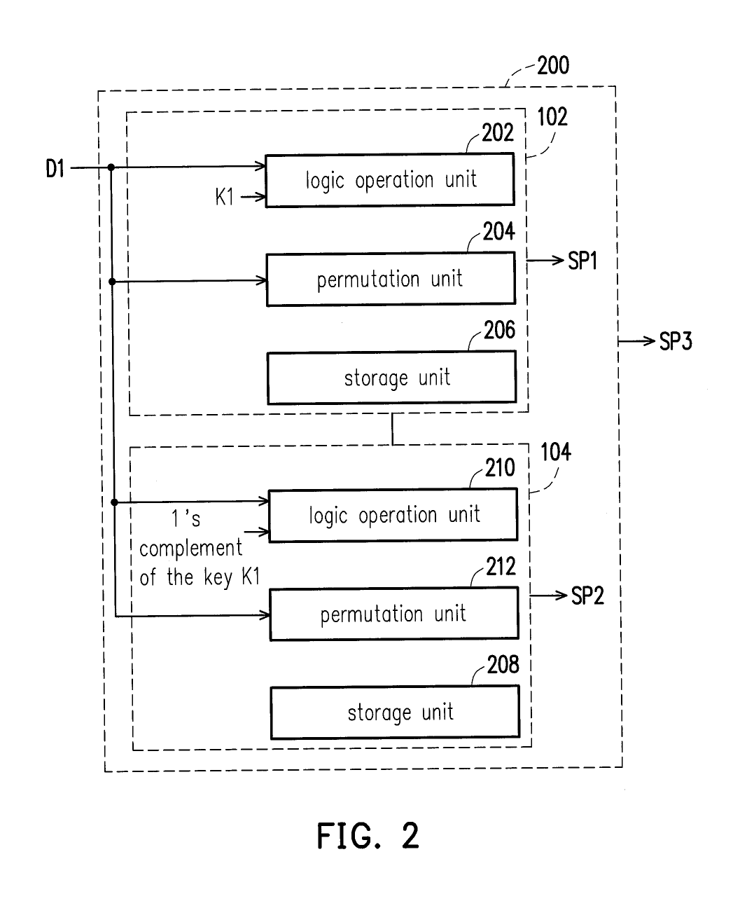

In some embodiments, the encryption/decryption apparatus is as shown in FIG. 2. FIG. 2 is a schematic view illustrating an encryption/decryption apparatus according to another embodiment of the invention. In this embodiment, the data encryption/decryption unit 102 of an encryption/decryption apparatus 200 includes a logic operation unit 202, a permutation unit 204, and a storage unit 206, whereas the complementary power generating unit 104 includes a storage unit 208, a logic operation unit 210, and a permutation unit 212. In other embodiments, the logic operation units 202 and 210 may be incorporated into a logic operation unit. The logic operation units 202 and 210 may perform the encryption/decryption logic operation to the digital data D1 according to the key K1, and the logic operation units 202 and 210 may include, for example, an exclusive-OR gate. Namely, the encryption/decryption logic operation may be, for example, an exclusive OR operation. The storage unit 206 may store a digital data permutation table, such that the permutation unit 204 may perform a permutation operation to the digital data D1 according to the digital data permutation table. In addition, when performing the permutation operation and/or the encryption/decryption logic operation, the encryption/decryption power signal SP1 corresponding to the permutation operation and/or the encryption/decryption logic operation is generated at the same time.

Besides, the logic operation unit 210 of the complementary power generating unit 104 of this embodiment may provide 1's complement of the key K1 in correspondence with the encryption/decryption logic operation of the logic operation unit 202, perform the encryption/decryption logic operation to the digital data D1 according to 1's complement of the key K1, and correspondingly generate the complementary power signal SP2 when performing the encryption/decryption logic operation.

In addition, the storage unit 208 may store a complementary data permutation table, wherein each value in the complementary data permutation table is 1's complement of a value in a corresponding position of the digital data permutation table. The complementary power generating unit 104 (more specifically, the permutation unit 212) may perform a permutation operation to the digital data D1 according to the complementary data permutation table and generates the complementary power signal SP2 corresponding to the permutation operation and/or the encryption/decryption logic operation when the permutation operation and/or the encryption/decryption logic operation is performed.

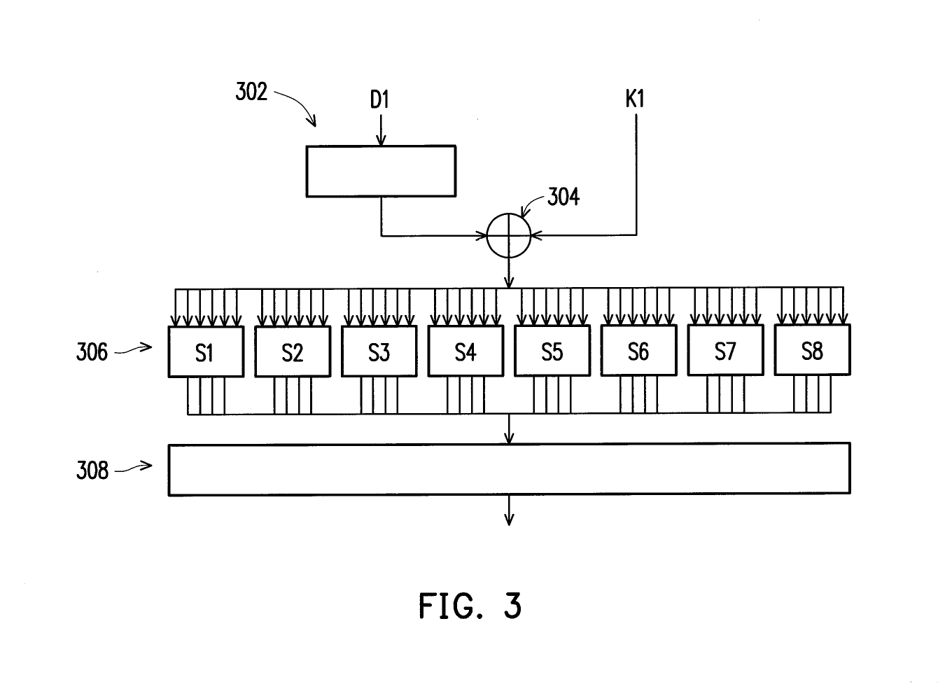

Specifically, the encryption/decryption apparatus 200 of this embodiment may be applied in an encryption method of the Feistel Function of FIG. 3, for example. As shown in FIG. 3, the encryption method of the Feistel Function includes an expansion step 302, a key-mixing step 304, a S-box permutation step 306, and a permutation step 308, etc. In this embodiment, the digital data D1 may be a 32-bit bit data, whereas the key K1 is a 48-bit bit data. The expansion step 302 serves to expand the digital data D1 into a 48-bit bit data. In the key-mixing step 304, the exclusive OR operation is performed to the expanded digital data D1 and the key K1. The operation may be performed by the logic operation unit 202.

The digital data D1 after the exclusive OR operation is divided into eight 6-bit blocks. In the S-box permutation step 306, data in each block is transformed into a non-linear data. As shown in FIG. 3, S-boxes S1-S8 respectively transforms one corresponding of the 6-bit data into a 4-bit data through table-walking. The difficulty of compromising a password increases after the non-linear transformation. The S-box permutation step 306 may be performed by the permutation unit 204 by performing a non-linear permutation operation to the digital data D1 according to the digital data permutation table stored in the storage unit 206. In addition, the permutation step 308 serves to re-combine the digital data D1 after non-linear transformation.

Generally speaking, in a condition that there is no complementary power generating unit of this embodiment, the hacker may choose to measure the encryption/decryption power signal SP1 of the encryption/decryption apparatus 200 at the key-mixing step 304 and the S-box permutation step 306, so as to perform power analysis attack. More specifically, if the hacker is allowed to input a data, a value of the key may be detected by modifying a value of the data input (as described in the embodiment in the following paragraph). In addition, the hacker may know the value of the key by observing an encryption/decryption power signal correspondingly generated when the encryption/decryption apparatus 200 operates. However, having the complementary power signal SP2 generated by the complementary power generating unit 104 of this embodiment makes the power signal SP3 eventually outputted by the encryption/decryption device 200 in correspondence with the encryption/decryption operation be kept at a fixed value, thereby preventing the key from being compromised.

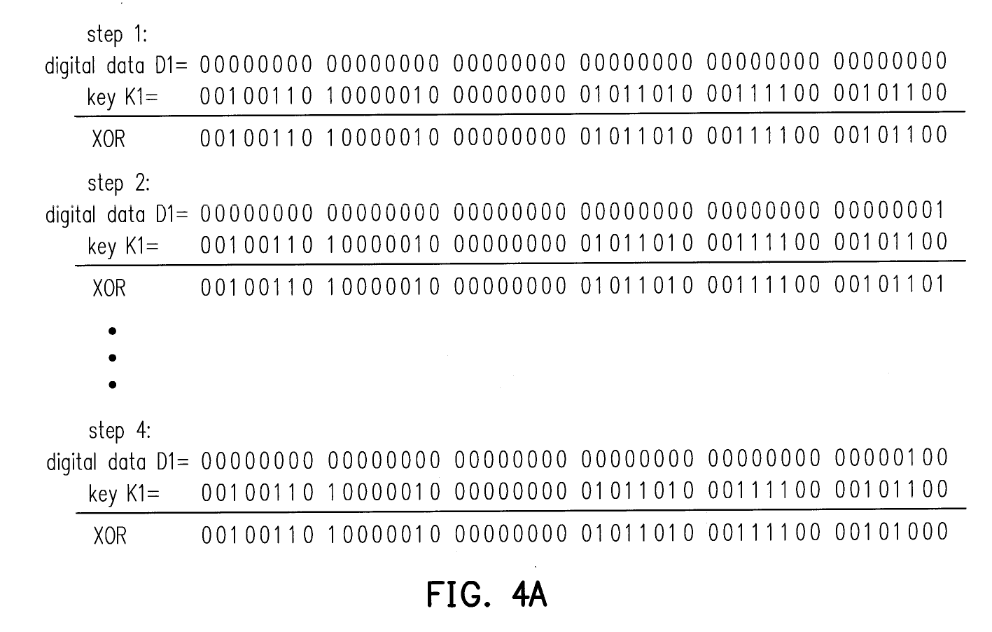

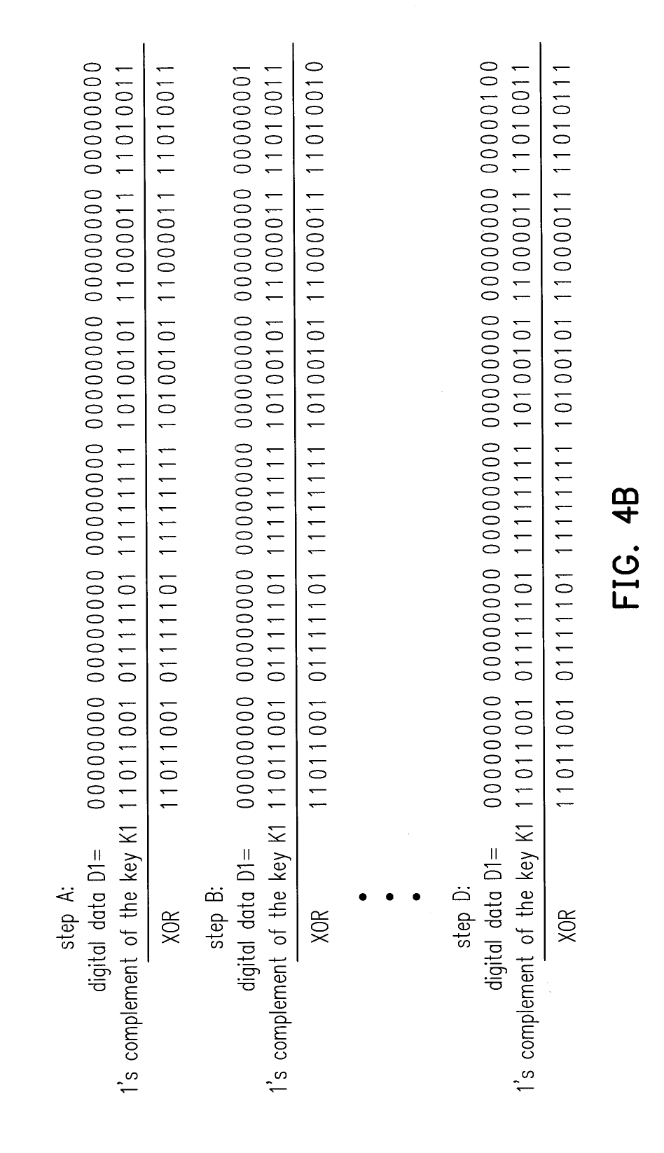

Specifically speaking, in the key-mixing step 304, the logic operation unit 202 and the complementary power generating unit 104 (more specifically, the logic operation unit 210)'s performing of the exclusive OR operation to the digital data D1 according to the key K1 is illustrated in the schematic views shown in FIGS. 4A and 4B. When it is intended to conduct power analysis attack to the encryption/decryption power signal SP1 correspondingly generated by the encryption/decryption apparatus 200, the value of the key may be detected by modifying a value of the digital data D1. As shown in Step 1 of FIG. 4A, it may be designed to set a value at each bit position in the input digital data D1 to be “0” at the beginning. Then, after performing the exclusive OR operation, there are 16 bits in the digital data D1 changing from “0” to “1”. The change of bit value is then reflected on a value of the encryption/decryption power signal SP1. For example, a current value may change with the change of bit value. Afterwards, the digital data D1 having one bit position as “1” and the rest bit positions as “0” are input sequentially, and the bit position of “1” in the digital data D1 is moved at each input, such that a power change reflected in the encryption/decryption signal SP1 is known, as shown in Step 2 or 4 in FIG. 4A. A power change corresponding to the change of bit value from “0” to “1” is different from a power change corresponding to the change of bit value from “1” to “0”. Thus, by observing the power change, the change of bit value may be inferred, and the value of the key is thereby detected.

For example, in Step 2 of FIG. 4A, after the exclusive OR operation, there are 16 bits in the digital data D1 changing from “0” to “1”, which is the same as the change of bit value of the digital data D1 in Step 1. Therefore, the value of the encryption/decryption power signal SP1 correspondingly generated by the data encryption/decryption unit 102 at this time does not change, indicating that a bit value of the lowest bit position in the key K1 is “0”. Another example is that in Step 4, after the exclusive OR operation, there are 15 bits in the digital data D1 changing from “0” to “1” and one bit changing from “1” to “0”, which is different from the change of bit value of the digital data D1 in Step 1. At this time, the value of the encryption/decryption power signal SP1 changes, indicating that in the key K1, a bit value of a bit position corresponding to a bit position having a bit value of “1” in the digital data D1 is “1”. Therefore, in this embodiment, by sequentially moving “1” from a lower bit position to a higher bit position, and by observing the power change, the bit value of the key K1 may be inferred, thereby detecting the key K1. (To simplify the description of this embodiment, only a process of moving three positions is described)

Similarly, the logic operation unit 210 also performs the exclusive OR operation to the digital data D1 with the logic operation unit 202 at the same time. As shown in Step A in FIG. 4B, the logic operation unit 210 first provides 1's complement of the key K1, then performs the exclusive OR operation according to 1's complement of the key K1 and the digital data D1. After performing the exclusive OR operation, there are 32 bits of the digital data D1 changing from “0” to “1”. Afterwards, the digital data D1 having one bit position as “1” and the rest bit positions as “0” are input sequentially, and the bit position of “1” in the digital data D1 is moved at each input. Similarly and as described in step A, in Steps B and D, 1's complement of the key K1 is provided first, and then the exclusive OR operation is performed according to 1's complement of the key K1 and the digital data D1, wherein there are 31 bits changing from “0” to “1” and one bit changing from “1” to “0” in step B, whereas there are 32 bits changing from “0” to “1” in step D.

Based on the above, it is known that when the number of bit value “1” in the digital data D1 is fixed (such as inputting the digital data D1 having one bit position as “1” and the rest bit positions as “0”), for example, and the logic operation unit 202 and the logic operation unit 210 performs the exclusive OR operation at the same time, a sum of the change of bit value is a fixed value. Namely, a change of step 2 and step B together and a change of step 4 and step D together identically show that there are 47 bits changing from “0” to “1”, and one bit changing from “1” to “0”. Therefore, the sum of the encryption/decryption power signal SP1 and the complementary power signal SP2 is a fixed value. Namely, the power signal SP3 of the encryption/decryption apparatus 200 is a fixed value. Therefore, when the hacker is allowed to input data, there is no change regarding the value of the power signal SP3 when the key K1 is tested by moving the bit position of “1”, making it unable to compromise the key K1 by using power analysis attack.

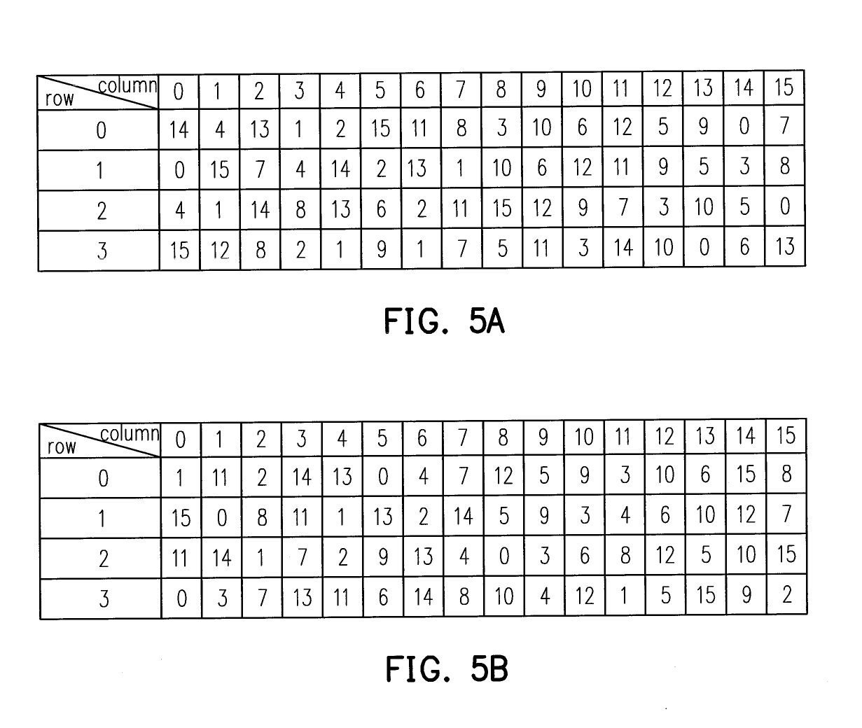

Besides, in the S-box permutation step 306, a similar way may be applied to keep the power signal SP3 at a fixed value. The digital data permutation table with which the permutation unit 204 performs the non-linear permutation operation to the digital data D1 is shown in FIG. 5A (taking the S-box S1 as an example). For example, given that a bit data received by the S-box S1 is “011001”, the permutation unit 204 may take the first bit and the last bit, namely “01”, as a row value in table-walking, and use the four intermediate values “1100” as a column value in table-walking. Based on the digital data permutation table shown in FIG. 5A, the value obtained through table-walking is 9 (i.e. “1001”).

Similarly, the complementary power generating unit 104 (more specifically, the permutation unit 212) and the permutation 204 also perform the permutation operation to the digital data D1 at the same time. The complementary data permutation table with which the complementary power generating unit 104 performs the non-linear permutation operation is shown in FIG. 5B (taking the S-box S1 as an example). As shown in FIG. 5B, each value in the complementary data permutation table is 1's complement of the value in the corresponding position of the digital data permutation table. Therefore, the value obtained by the complementary power generating unit 104 through table-walking is “6” (i.e. “0110”).

Based on the above, it is known that when the permutation unit 204 and the permutation unit 212 of the complementary power generating unit 104 perform the permutation operation at the same time, a total bit value is constantly a fixed value of 15 (i.e. “1111”). Therefore, there is no change in the value of the power signal SP3 measured by the hacker.

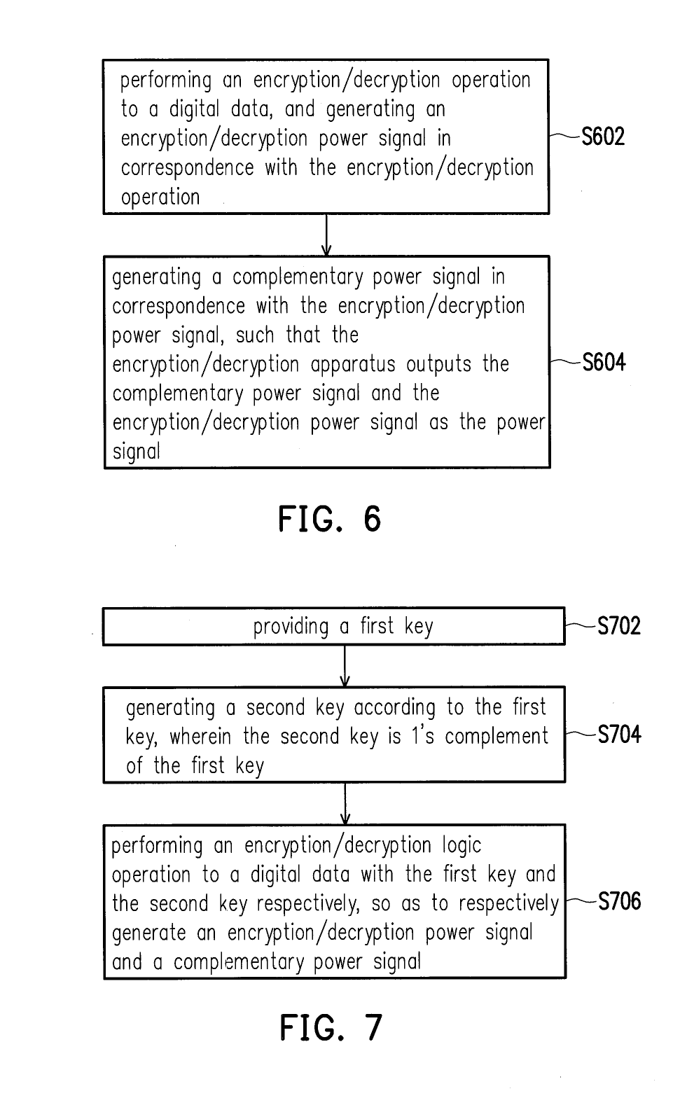

FIG. 6 is a flowchart illustrating an encryption/decryption method according to an embodiment of the invention. Referring to FIG. 6, an encryption/decryption method of the encryption/decryption apparatus above may include the following. First, an encryption/decryption operation is performed to a digital data, and an encryption/decryption power signal is generated in correspondence with the encryption/decryption operation (Step S602). Then, a complementary power signal is generated in correspondence with the encryption/decryption power signal, such that the encryption/decryption apparatus outputs the complementary power signal and the encryption/decryption power signal as the power signal (Step S604), wherein a sum of the complementary power signal and the encryption/decryption power signal is a fixed value. More specifically, the encryption/decryption operation may include an encryption/decryption logic operation and a permutation operation, wherein the permutation operation may be performed according to a digital data permutation table. In addition, when generating the complementary power signal in correspondence with the permutation operation, the permutation operation may be performed according to a complementary data permutation table, so as to correspondingly generate the complementary power signal, wherein each value in the complementary data permutation table is 1's complement of a value in a corresponding position in the digital data permutation table. Correspondingly generating an encryption/decryption power signal and a complementary power signal according to another embodiment is shown in FIG. 7. First, a first key is provided (Step S702). Then, a second key is generated according to the first key, wherein the second key is 1's complement of the first key (Step S704). Then, an encryption/decryption logic operation is performed to a digital data with the first key and the second key respectively, so as to respectively generate an encryption data. When generating the encryption data, the encryption/decryption power signal and the complementary power signal are correspondingly generated (Step S706), wherein a sum of the encryption/decryption power signal and the complementary power signal is a fixed value.

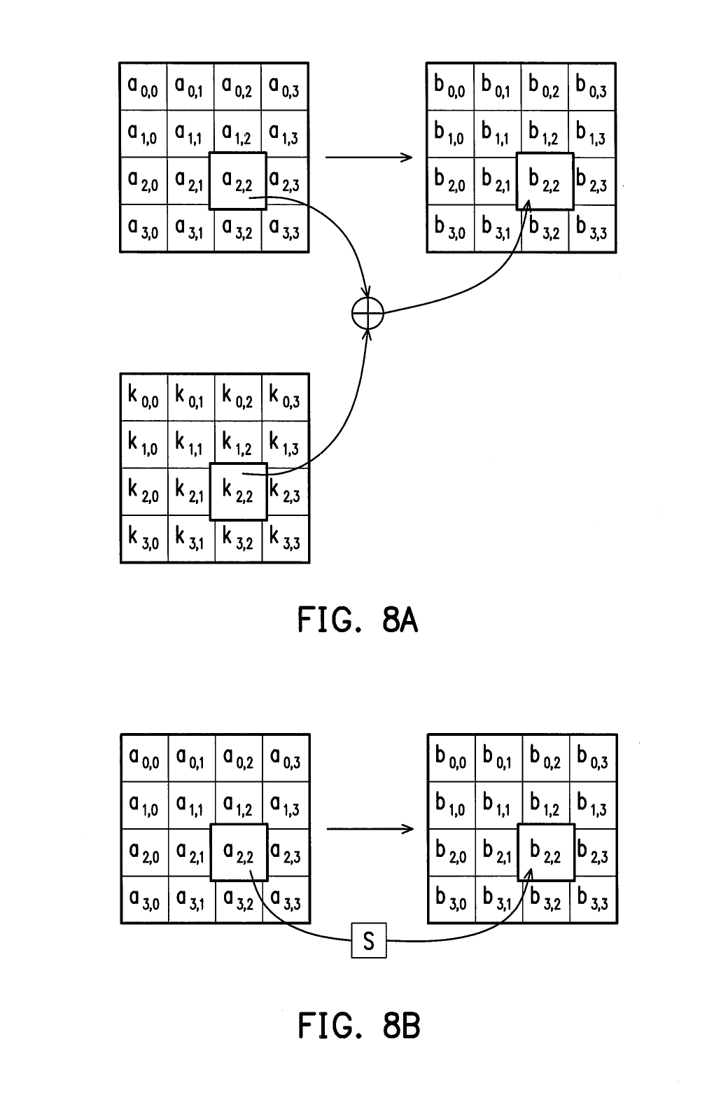

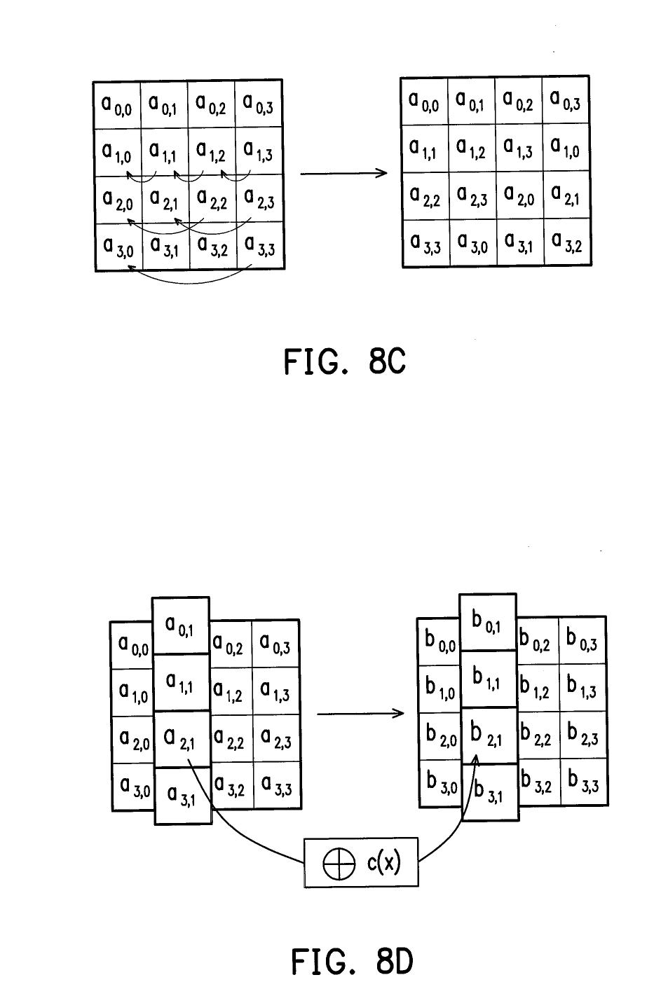

Although the embodiments above use the Feistel Function to describe the encryption/decryption apparatus and the encryption/decryption method thereof of the embodiments of the invention for defending power analysis attack, the encryption/decryption apparatus and the encryption/decryption method thereof of the embodiments of the invention is not limited to be only applicable to the data encryption standard (DES). The encryption/decryption apparatus and the encryption/decryption method thereof of the embodiments of the invention is also applicable in other encryption standards to defend power analysis attack. For example, encryption/decryption of the advanced encryption standard (AES) includes steps of AddRoundKey, SubBytes, ShiftRows, and MixColumns, etc. FIGS. 8A-8D are schematic views illustrating encryption/decryption in the advanced encryption standard (AES) according to an embodiment of the invention.

As shown in FIG. 8A, in the step of AddRoundKey, each byte (a_{m,n}) in a matrix is performed with an exclusive OR operation with a round key (K_{m,n}), thereby generating an encrypted/decrypted byte (b_{m,n}), wherein m and n are positive integers. Since the above is very similar to the exclusive OR operation in the data encryption standard, the same way (i.e. using 1's complement of the key) may be used to generate a complementary power signal to prevent the key from being compromised.

As shown in FIG. 8B, in the step of SubBytes, a non-linear substitution formula S is used to substitute each byte (a_{m,n}) with a corresponding byte (b_{m,n}) through a look-up table, similar to the S-box permutation step above. Therefore, in the step of SubBytes, the same way (i.e. using 1's complement of the key) may be used to generate the complementary power signal.

As shown in FIG. 8C, in the step of ShiftRows, each row in the matrix is cycle-shifted. Since there is no encryption/decryption power signal corresponding to this operation, it is not necessary to generate the complementary power signal to prevent the key from being compromised.

As shown in FIG. 8D, in the step of MixColumns, a linear transformation, which is actually extended binary field polynomial multiplication, including extended binary field addition and extended binary field multiplication, is used to mix four bytes in each column. The extended binary field multiplication may be implemented through table-walking. Namely, the S-box described above may be used to generate the complementary power signal. In addition, regarding the extended binary field addition, an EQU operation (i.e. complement operation of the exclusive OR operation) may be used to generate the complementary power signal to prevent the key from being compromised. More specifically, the four bytes in each column are combined through a linear transformation, wherein four elements a₀ to a₃ in each column respectively serve as coefficients of 1, x, x², and x³. A byte a(x) before the linear transformation and a linear transformation formula c(x) may be represented in the following equations.

a(x)=a₃x³+a₂x²+a₁x+a₀ (1)

c(x)=c₃x³+c₂x²+c₁x¹+c₀ (2)

Bytes b₀ to b₃ after transformation are shown in the following.

b₀=a₀·c₀⊕a₃·c₁⊕a₂·c₂⊕a₁·c₃

b₁=a₁·c₀⊕a₀·c₁⊕a₂·c₃⊕a₃·c₂

b₂=a₂·c₀⊕a₀·c₂⊕a₁·c₁⊕a₃·c₃

b₃=a₃·c₀⊕a₀·c₃⊕a₂·c₁⊕a₁·c₂

In view of the above, even though encryption/decryption in the advanced encryption standard (AES) is different from the data encryption standard, it still uses basic operations such as the encryption/decryption logic operation and permutation operation above for encryption/decryption. Therefore, the encryption/decryption apparatus and the encryption/decryption method thereof in the embodiments of the invention is also applicable in the advanced encryption standard to keep the power signal generated when performing encryption/decryption operation at a fixed value, thereby effectively defending power analysis attack.

In view of the foregoing, the embodiments of the invention utilize the complementary power generating unit to provide the complementary power signal complementary to the encryption/decryption power signal correspondingly generated when the data encryption/decryption unit performs the encryption/decryption operation, so as to keep the power signal outputted by the encryption/decryption apparatus at a fixed value, thereby effectively defending power analysis attack.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An encryption/decryption apparatus, adapted to perform an encryption/decryption operation to a digital data and generating a power signal corresponding to the encryption/decryption operation when the encryption/decryption operation is performed, the encryption/decryption apparatus comprising:
a data encryption/decryption unit, performing the encryption/decryption operation to the digital data and generating an encryption/decryption power signal in correspondence with the encryption/decryption operation; and
a complementary power generating unit, coupled to the data encryption/decryption unit and generating a complementary power signal in correspondence with the encryption/decryption power signal, such that the encryption/decryption apparatus outputs the complementary power signal and the encryption/decryption power signal as the power signal, wherein a sum of the complementary power signal and the encryption/decryption power signal is a fixed value.

2. The encryption/decryption apparatus as claimed in claim 1, wherein the encryption/decryption operation is an encryption/decryption logic operation, and the data encryption/decryption unit performs the encryption/decryption logic operation to the digital data according to a key.

3. The encryption/decryption apparatus as claimed in claim 2, wherein the complementary power generating unit further provides 1's complement of the key and performs the encryption/decryption logic operation to the digital data according to 1's complement of the key, so as to correspondingly generate the complementary power signal.

4. The encryption/decryption apparatus as claimed in claim 2, wherein the encryption/decryption logic operation is an exclusive OR operation.

5. The encryption/decryption apparatus as claimed in claim 1, wherein the data encryption/decryption unit comprises:
a first storage unit, storing a digital data permutation table; and
a permutation unit, performing a permutation operation to the digital data according to the digital data permutation table, and generating the encryption/decryption power signal in correspondence with the permutation operation.

6. The encryption/decryption apparatus as claimed in claim 5, wherein the complementary power generating unit comprises:
a second storage unit, storing a complementary data permutation table, wherein the complementary power generating unit performs the permutation operation to the digital data according to the complementary data permutation table, so as to correspondingly generate the complementary power signal.

7. The encryption/decryption apparatus as claimed in claim 6, wherein each value in the complementary data permutation table is 1's complement of a value in a corresponding position in the digital data permutation table.

8. An encryption/decryption method of an encryption/decryption apparatus adapted to perform an encryption/decryption operation to a digital data, wherein the encryption/decryption apparatus generates a power signal corresponding to the encryption/decryption operation when the encryption/decryption operation is performed, the encryption/decryption method of the encryption/decryption apparatus comprising:
performing the encryption/decryption operation to the digital data and generating an encryption/decryption power signal in correspondence with the encryption/decryption operation; and
generating a complementary power signal in correspondence with the encryption/decryption power signal, such that the encryption/decryption apparatus outputs the complementary power signal and the encryption/decryption power signal as the power signal, wherein a sum of the complementary power signal and the encryption/decryption power signal is a fixed value.

9. The encryption/decryption method of the encryption/decryption apparatus as claimed in claim 8, wherein performing the encryption/decryption operation to the digital data further comprises:
performing the encryption/decryption operation to the digital data according to a key.

10. The encryption/decryption method of the encryption/decryption apparatus as claimed in claim 9, wherein the encryption/decryption operation comprises an encryption/decryption logic operation, and generating the complementary power signal in correspondence with the encryption/decryption power signal comprises:
providing 1's complement of the key; and
performing the encryption/decryption logic operation to the digital data according to 1's complement of the key, so as to correspondingly generate the complementary power signal.

11. The encryption/decryption method of the encryption/decryption apparatus as claimed in claim 10, wherein the encryption/decryption logic operation is an exclusive OR operation.

12. The encryption/decryption method of the encryption/decryption apparatus as claimed in claim 8, wherein the encryption/decryption operation comprises a permutation operation, and generating the encryption/decryption power signal comprises:
performing a permutation operation to the digital data according to a digital data permutation table, and generating the encryption/decryption power signal in correspondence with the permutation operation.

13. The encryption/decryption method of the encryption/decryption apparatus as claimed in claim 12, wherein generating the complementary power signal according to the digital data comprises:
performing the permutation operation to the digital data according to a complementary data permutation table, so as to correspondingly generate the complementary power signal.

14. The encryption/decryption method of the encryption/decryption apparatus as claimed in claim 13, wherein each value in the complementary data permutation table is 1's complement of a value in a corresponding position in the digital data permutation table.

15. An encryption method, comprising:
providing a first key;
generating a second key according to the first key, wherein the second key is 1's complement of the first key; and
performing an encryption logic operation to a digital data with the first key and the second key respectively to respectively generate an encryption data.

16. The encryption method as claimed in claim 15, further comprising a permutation operation, respectively performing the permutation operation to the digital data according to a digital data permutation table and a complementary data permutation table, so as to respectively generate the encryption data.

17. The encryption method as claimed in claim 15, wherein the encryption/decryption logic operation is an exclusive OR operation.
